(19) United States
(12) Patent Application Publication
(10) Pub. No.: US 2007/0204435 A1
(43) Pub. Date: Sep. 6, 2007

(54) Ergonomic handle

(76) Inventor: Dominic J. Pangborn, Detroit, MI (US)

Correspondence Address: Mr. Dennis A. Bennett, Post Office Box 38100, St. Louis, MO, 63138, US

(21) Appl. No.: 11/527,019

(22) Filed: Sep. 25, 2006

Related U.S. Application Data
(60) Provisional application No. 60/721,650, filed on Sep. 29, 2005.

(51) Int. Cl. B25G 1/10

(52) U.S. Cl. 16/430

(57) ABSTRACT

There is disclosed a novel handle for use with a variety of hand held implements. The disclosed handle redistributes the weight of the implement from the wrist and hand to the forearm and elbow.

### RELATED APPLICATION(S)

This Application claims priority to U.S. provisional application Serial No. 60/721,650 filed Sep. 28, 2005.

### BACKGROUND OF THE INVENTION

1. Field of the Invention

The present invention relates generally to handles for hand supported implements and, more particularly, is directed to an ergonomic handle that redistributes the weight of a hand supported implement from the hand and wrist to the forearm and elbow. The ergonomic handle may be manufactured at a low cost from a single piece of material and provides superior aesthetics.

2. Description of the Prior Art

Conventional various ergonomic handles are well known in the art to prevent the user's wrist from moving in response to a loading situation and instead cause the load to be shifted or transferred to the forearm, elbow and muscles of the upper arm. However, those ergonomic handles usually have complex, large structures and are usually designed specifically for people who have a variety of physically injured conditions such as arthritis in the wrists, infirm forearm muscles or carpal tunnel syndromes. These ergonomic handles have not been commonly used by relatively healthy people for household utensils, garden tools or fishing tools. The prior art ergonomic handles are not easy to use because they require a different holding position different from most users' daily habits, especially when applying to cooking pots. Another reason may be that most of the ergonomic handles are not aesthetic.

It would be a great advantage to the general public if there was provided an aesthetic, ergonomic handle that will be attractive for people to use, while also redistributing the weight of a hand supported implement from the hand and wrist to the forearm and elbow, thereby preventing physical injuries.

### BRIEF DESCRIPTION OF THE DRAWINGS

For a further understanding of the nature and advantages of the expected scope and various embodiments of the present invention, reference shall be made to the following detailed description, and when taken in conjunction with the accompanying drawings, in which like parts are given the same reference numerals, and herein:

FIG. 1 is a side view of a first embodiment of an ergonomic handle made in accordance with the present invention;

FIG. 2 is a top view of the first embodiment of an ergonomic handle;

FIG. 3 shows the first embodiment used on a cooking pan;

FIG. 4 shows the first embodiment used on a trimmer;

FIG. 5 shows the first embodiment used on a fishing rod;

FIG. 6 is a side view of a second embodiment of an ergonomic handle made in accordance with the present invention; and

FIG. 7 is a side view of a third embodiment of an ergonomic handle made in accordance with the present invention.

FIG. 8 is a disassembled side view of a forth embodiment of an ergonomic handle of the present invention where the forearm support portion is hinge ably attached to the rest of the handle.

FIG. 9 is an assembled side view of the forth embodiment.

### DETAILED DESCRIPTION OF THE INVENTION

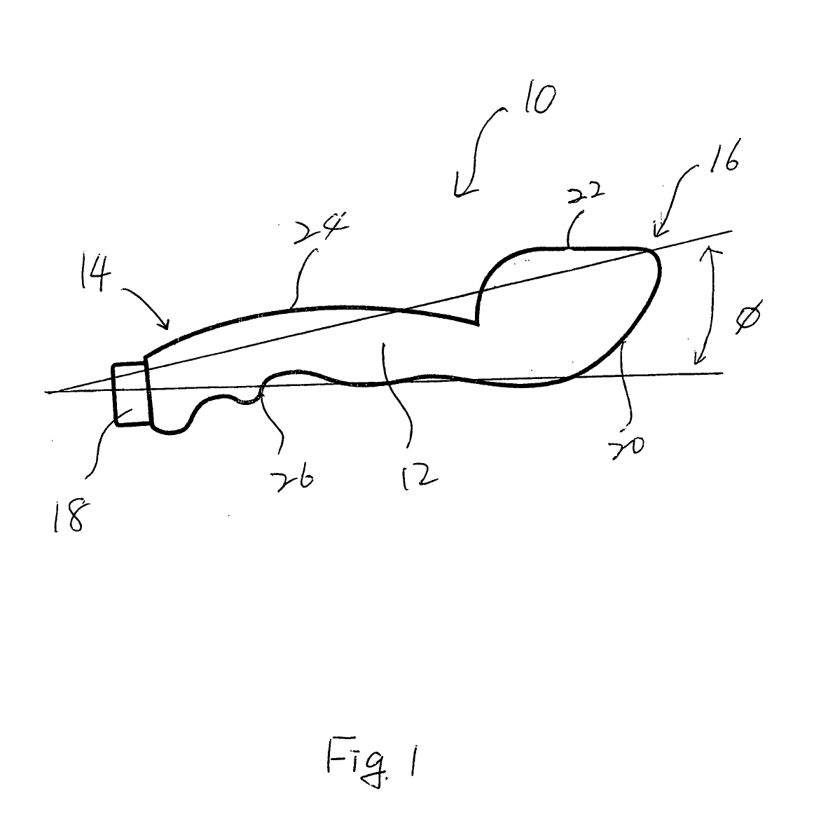

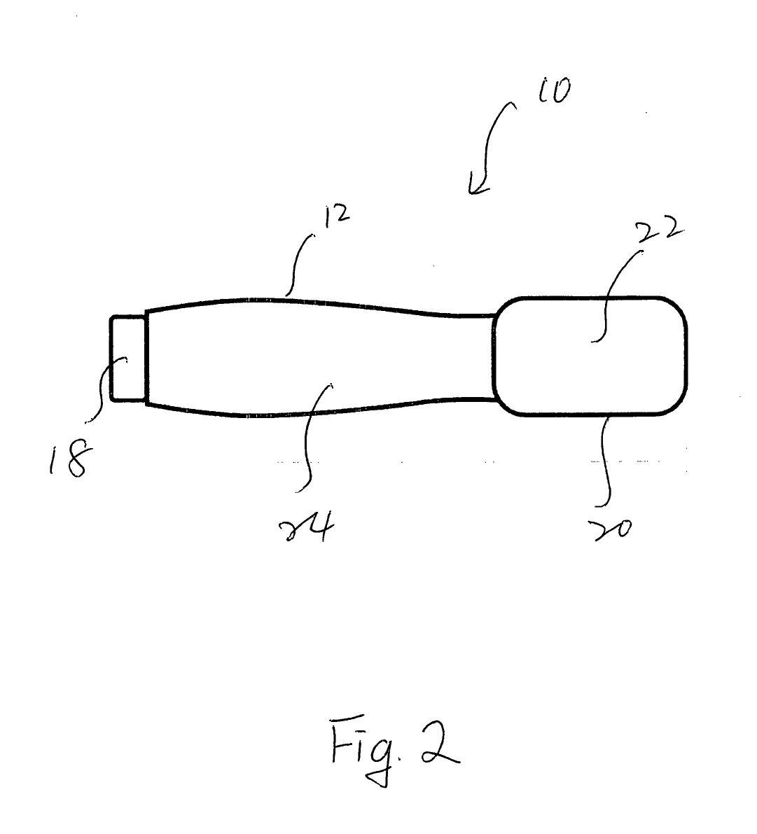

Referring now to the drawings in detail, FIG. 1 and FIG. 2 are views of a first embodiment of an ergonomic handle made in accordance with the present invention, generally indicated by the numeral 10. The ergonomic handle 10 is formed with an elongated handle portion 12 sized to engage a substantial portion of a hand of a user and has a proximal end generally indicated by the numeral 14 and a distal end generally indicated by the numeral 16.

The proximal end 14 includes a fastener 18 for attaching the handle 10 to a hand supported implement (not shown) or can be permanently attached to a hand supported implemented. Any fastener for fastening and joining known to those skilled in the art including screws, glue, bolts, clamps, clips, rivets, hooks, clasps, latches, nuts, pins, pegs, slots, and slits and the like, amongst others may be used to attach the handle 10 any hand supported implement.

The distal end 16 includes a knob-shaped forearm support portion 20 having a top surface 22 for supporting against the underside of the user's forearm (not shown). The elongated handle portion 12 and the knob-shaped forearm support portion 20 may be oriented with respect to one another at an upward angle of between about 5 and 40 degrees from a substantially horizontal axis defined by the longitudinal axis of the handle 10 and the longitudinal axis of the upper surface of the knob-shaped forearm support portion 20.

This angle range is ergonomically correct to allow greater support while lifting. This ergonomic design. is more comfortable to use than other handles, while providing a means to lift more weight comfortably. As previous handles are generally longer in length, it is believed to be an advantage for most applications to provide a shorter handle to alleviate obstruction caused by the handle. Research done on many applications indicates a shorter handle works well, if not better, than a longer handle. Measurements were taken from the wrist of a user to the elbow of an average human. The handle is preferably designed to extend less than one quarter the distance extending between the wrist and the elbow along the underside of the forearm of an average user. The length of the distance between the wrist and the elbow may be described as d_{we} and the length of the handle (lₕ) is then preferably ¼d_{we}≦lₕ≦½d_{we}.

This handle length minimizes hindrance of use for many applications, while longer handles may be more suitable for other applications. As a result of the shape of the knob-shaped forearm support portion 20, top surface 22 inhibits the handle 10 from slipping out of a hand when in use.

For certain applications, like for landscaping tools and heavier lifting requirements, the knob-shaped forearm support portion 20 and overall length of the handle 10 may be sized to engage between about one forth and one half length of the forearm of the user. Preferably, for lighter weight applications, the overall length of the handle 10, including the knob-shaped forearm support portion 20, may not be longer than one third (⅓) of the length of the user's forearm.

The elongated handle portion 12 may further include an upwardly directed convex top surface 24 and a bottom surface 26. Convex top surface 24 substantially supports the user's palm (not shown) and provides comfort for the user. The bottom surface 26 may have a least one indention portion for receiving fingers of the user and increasing friction between the user's hand and the ergonomic handle 10.

To use the ergonomic handle 10 of the present invention as shown in FIG. 1, a user simply grips the elongated handle portion 12 with his hand and places his forearm on the knob-shaped forearm support portion 20. When the ergonomic handle 10 is lifted, causing the handle supported implement to be lifted as well, the knob-shaped forearm support portion 20 prevents the ergonomic handle 10 and the hand supported implement from slipping out of the user's hand.

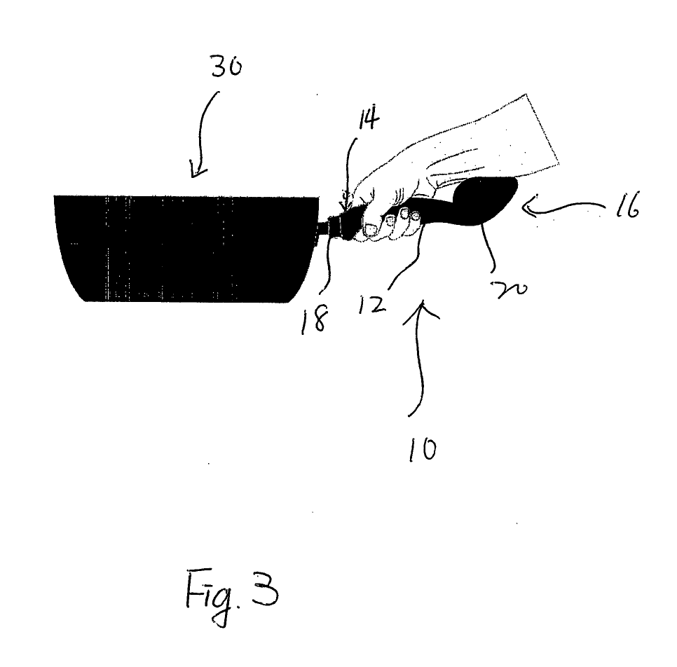

FIG. 3 show the first embodiment in use with a hand supported implement (a cooking pan) generally indicated by the numeral 30. In this preferred embodiment, a cooking pan 30 is permanently attached to the proximal end 14 of the elongated handle portion 12.

Furthermore, the knob-shaped forearm support portion 20 of handle 10 is sized to support a forearm. Thus, the knob-shaped forearm support portion 20 redistributes the weight of the cooking pan 30 from the wrist to the muscles in the forearm and the elbow when the user's forearm is placed on the knob-shaped forearm support portion 20. The ergonomic handle 10 and the cooking pan 30 may also be manufactured as one integral piece, forming an ergonomic hand supported utensil and eliminating the need to separately produce the handle 10 and the cooking pan 30 and then permanently attach them.

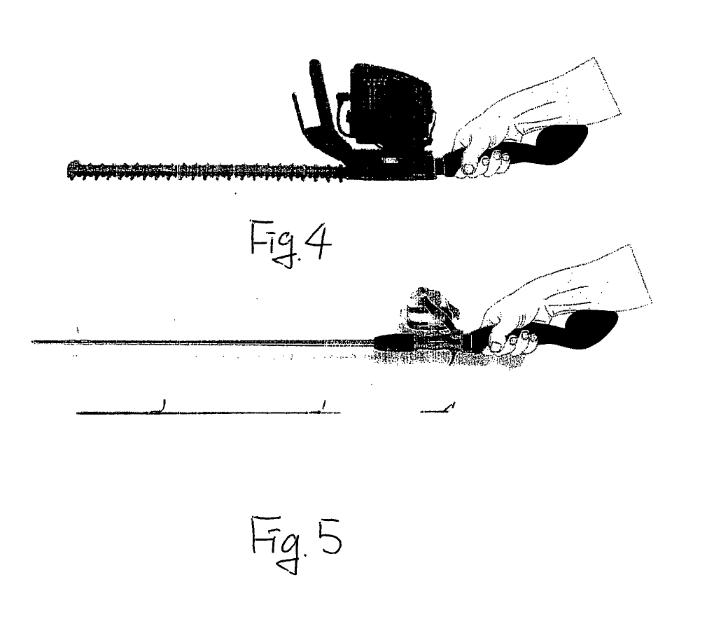

Although the hand supported implement 30 shown in FIG. 3 is a cooking pan, the ergonomic handle 10 can be used with a variety of different hand supported implements 30 including garden tools (see FIG. 4), carts, carriages, other types of cookware, fishing rods (see FIG. 5) and other fishing tools, nets, shovels, medical devices, climbing devices, snow-removing devices, jack-hammers, firearms, metal detectors, walking device, crow-bars, and wrenches or any suitable device. Furthermore, the ergonomic handle 10 of the present invention can be made of any material including polymeric materials, ceramics, minerals, and metals; however, when the hand supported implement 30 is a type of cookware, it is preferable that the hand supported implement 30 is at least partially manufactured from heat-resistant material. The ergonomic handle 10 of the present invention may be manufactured at a low cost from a single piece of material.

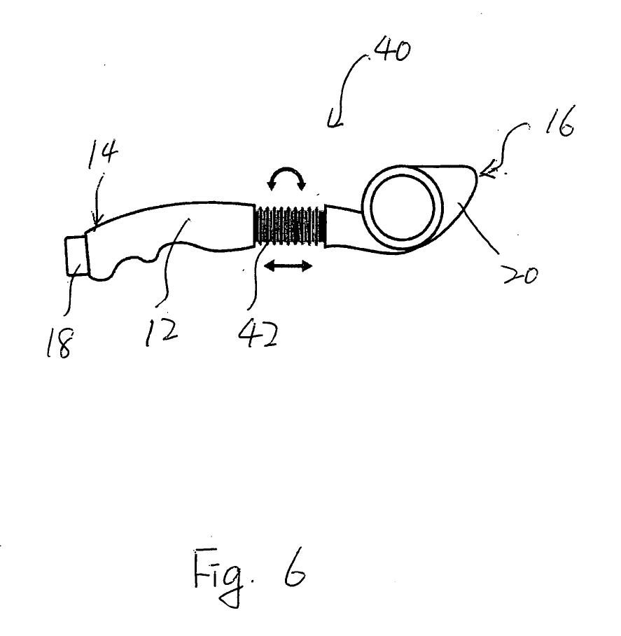

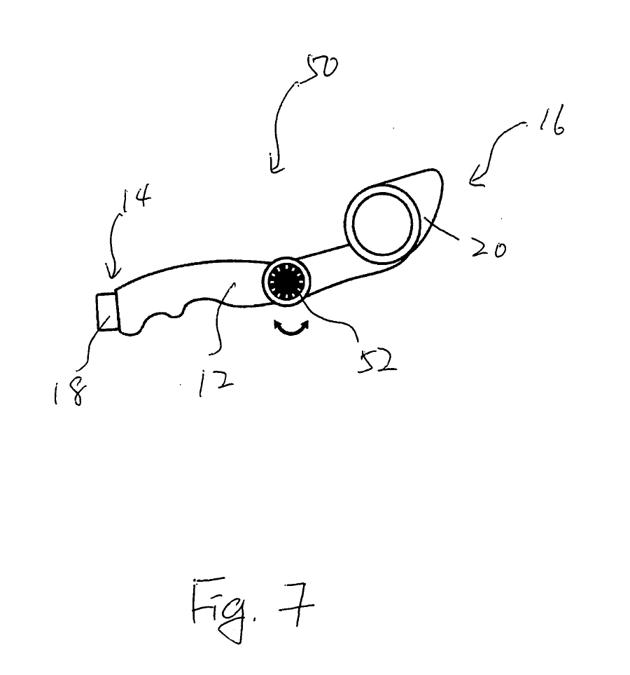

FIG. 6 is a side view of a second embodiment of an ergonomic handle generally indicated by the numeral 40 made in accordance with the present invention. The ergonomic handle 40 is substantially the same as the first embodiment as shown in FIG. 1 and FIG. 2. Like the first embodiment, the ergonomic handle 40 has an elongated handle portion 12 including a proximal end 14 with a fastener 18 and a distal end 16 with a knob-shaped forearm support portion 20. The ergonomic handle 40 further includes a telescoping member 42.

Telescoping member 42 may optionally locate in the middle of the elongated handle portion 12 or any other suitable location within the elongated handle portion 12. While the telescoping member 42 may be used to adjust the length of the elongated handle portion 12, it may be made of any suitable material such as polymeric materials.

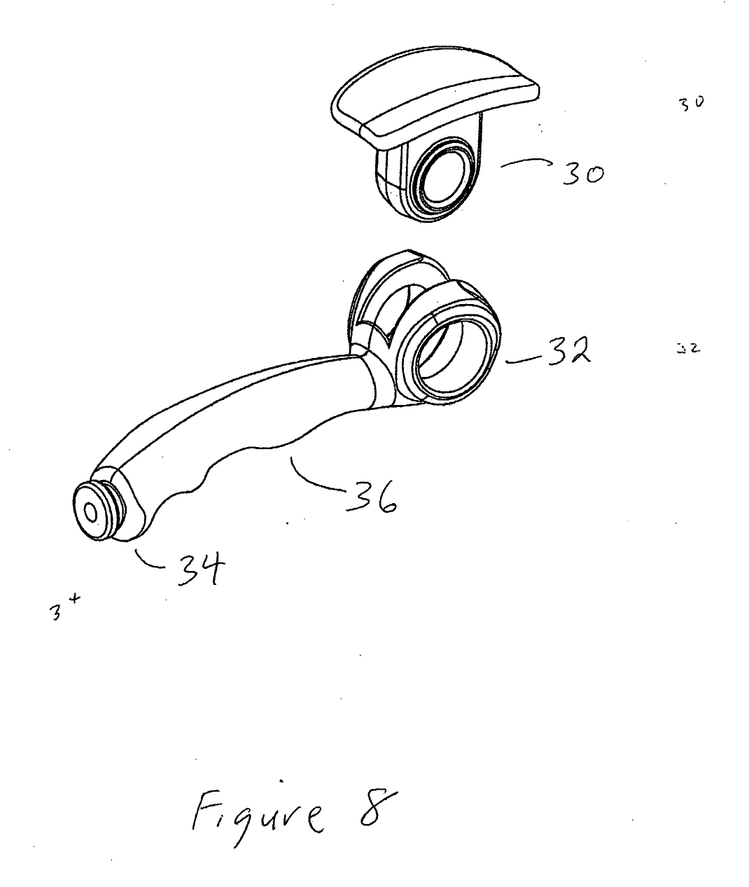

FIG. 7 is a side view of a third embodiment of an ergonomic handle generally indicated by the numeral 50 made in accordance with the present invention. The ergonomic handle 50 is substantially the same as the first embodiment as shown in FIG. 1 and FIG. 2. Like the first embodiment, the ergonomic handle 50 has an elongated handle portion 12 including a proximal end 14 with a fastener 18 and a distal end 16 with a knob-shaped forearm support portion 20. The ergonomic handle 40 further includes an articulating member 52.

Articulation member 52 may optionally be located in the middle of the elongated handle portion 12 or any other suitable location within the elongated handle portion 12. The articulation member 52 may be used to adjust the angle between the elongated handle portion 12 and the knob-shaped forearm support portion 20. Alternatively, the articulation member 52 may be placed within the knob-shaped forearm support portion 20 to further suit the user's forearm. For practical purposes, articulation member 52 may be made of any suitable material such as polymeric materials, ceramics, minerals, or metals.

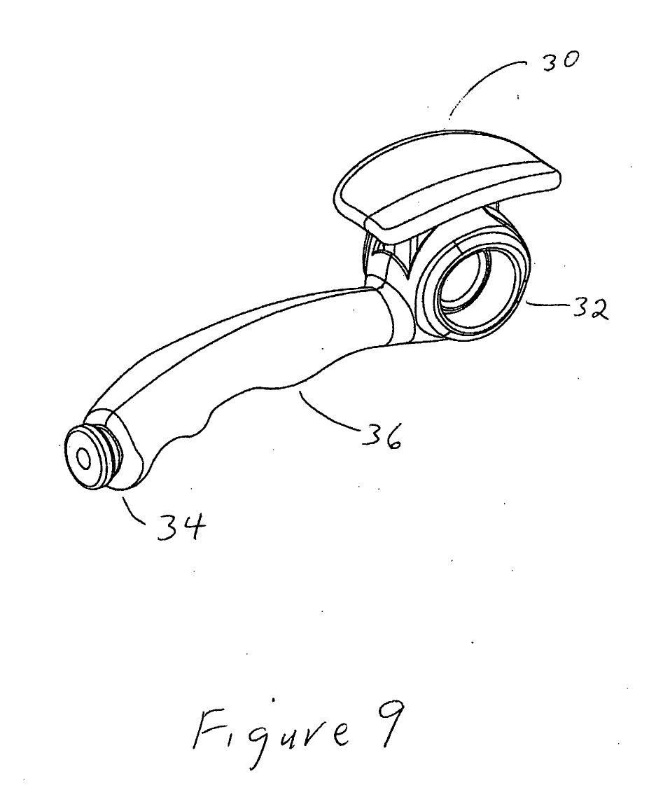

FIGS. 8 and 9 shows a forth embodiment of the present invention. Elongated handle portion 36 has a forearm support portion at distal end that is capable of rotating when the user extends his arm. The hinge is made up of the receiving member 30 and the male member 32. The receiving member 30 is rigidly attached to the elongated handle portion 36. A fastener 34 is attached at the proximal end of the elongated handle portion 36.

In summary, numerous benefits have been described which result from employing any or all of the concepts and the features of the various specific embodiments of the present invention, or those that are within the scope of the invention. As will be appreciated, the previously described versions of the present invention have many advantages, including: redistributing the weight of the hand supported implement from the wrist to forearm muscles and elbow, providing the knob-shaped forearm support portion 20 to prevent the hand supported implement from slipping out of a hand while in use and providing superior aesthetics.

A problem often associated with conventional handles is that these ergonomic handles are not easy to be adapted while they require a different holding position against most users' daily habits, especially when applying to cooking pans. The ergonomic handle 10 of the present invention provides a handle which is shaped and angled so as to prevent the hand supported implement from slipping out of a hand, while providing a knob-shaped forearm support portion 20 that permits a more natural and stable wrist hand position to prevent physical injuries. The invention also satisfies the need for a handle, which utilizes a lever principal to transfer the weight of the hand supported implement from the wrist to forearm muscles and elbow. In addition, the invention provides an ergonomic handle 10 which may be manufactured at a low cost form a single piece of material and has superior aesthetics.

The foregoing description of preferred embodiments of the invention has been presented for purposes of illustration and description. It is not intended to be exhaustive or to limit the invention to the precise form disclosed. Obvious modifications or variations are possible in light of the above teachings with regards to the specific embodiments. The embodiments were chosen and described in order to best illustrate the principles of the invention and its practical applications to thereby enable one of ordinary skill in the art to best utilize the invention in various embodiments and with various modifications as are suited to the particular use contemplated.

1. A handle, comprising;
An elongated handle portion having a proximal end, a distal end, a top and bottom surface;
A forearm support portion attached at the distal end of said elongated handle with a top surface for supporting the underside of a user's forearm;
Said forearm support portion is oriented at an upward angle of between 5-40° to said elongated handle portion;
Said top surface of said elongated handle portion and said top surface of said forearm support portion are substantially parallel to one another; and
An implement fastener attached to said proximal end of said elongated handle portion.

2. The handle as recited in claim 1 wherein said elongated handle portion top and bottom surfaces are upwardly convex.

3. The handle as recited in claim 1 wherein said bottom of said elongated handle portion has at least one indention portion for receiving fingers of a user.

4. The handle as recited in claim 1 wherein said handle is made of a single piece of plastic.

5. The handle as recited in claim 1 wherein said forearm support portion is knob-shaped.

6. The handle as recited in claim 1 further comprising an articulating member within said elongated handle portion.

7. The handle as recited in claim 1 further comprising a telescoping member within said elongated handle portion.

8. The handle as recited in claim 1 wherein said forearm support portion extends less than or equal to half way up the underside of a user's forearm.

9. The handle as recited in claim 1 wherein said forearm support portion extends less than or equal to one quarter the way up the underside of a user's forearm.

10. The handle as recited in claim 1 wherein said forearm support portion is hinge ably attached to said elongated handle.

11. A handle, comprising;
An elongated handle portion having a proximal end, a distal end, a top and bottom surface;
A forearm support portion hinge ably attached at the distal end of said elongated handle with a top surface for supporting the underside of a user's forearm;
Said forearm support portion is oriented at an upward angle of between 5-40° to said elongated handle portion; and
An implement fastener attached to said proximal end of said elongated handle portion.
